(19) United States
(12) Patent Application Publication
(10) Pub. No.: US 2026/0258289 A1
(43) Pub. Date: Sep. 3, 2026

(54) REACTIVE HOT-MELT ADHESIVE HAVING LOW CONTENT OF MONOMERIC DIISOCYANATES

(71) Applicant: SIKA TECHNOLOGY AG, Baar (CH)

(72) Inventors: Martin SCHMIDER, Lüneburg (DE); Andreas KRAMER, Zürich (CH); Michael GEYER, Schaffhausen (CH)

(73) Assignee: SIKA TECHNOLOGY AG, Baar (CH)

(21) Appl. No.: 18/875,326

(22) PCT Filed: Jun. 28, 2023
(86) PCT No.: PCT/EP2023/067622

§ 371 Date: Dec. 16, 2024

(30) Foreign Application Priority Data
Jul. 4, 2022 (EP) 22182817.1

(51) Int. Cl. C09J 175/06; C09J 11/08

(52) U.S. Cl. CPC C09J 175/06; C09J 11/08

(57) ABSTRACT

An adhesive composition including at least one isocyanate-functional polyurethane polymer and having a low content of monomeric diisocyanates. Also, a method for producing the adhesive composition, to the use of the adhesive composition as an assembly adhesive, laminating adhesive, or as adhesive for building of sandwich elements, and a method for bonding substrates to each other.

### TECHNICAL FIELD

The invention relates to reactive polyurethane-based hot-melt adhesives having low content of monomeric diisocyanates and to use of adhesives as an assembly adhesive, a laminating adhesive, or as an adhesive for the building of sandwich elements, particularly in automotive industry.

### BACKGROUND OF THE INVENTION

Hot-melt adhesives are solvent free adhesives, which are solid at room temperature, and which are applied to the substrate to be bonded in form of a melt. After cooling the adhesive solidifies and forms an adhesive bond with the substrate through physically occurring bonding. Conventional hot-melt adhesives are non-reactive adhesives, which soften again upon heating and are, therefore, not suitable to be used at elevated temperatures. Reactive hot-melt adhesives contain polymers with reactive groups that enable chemical curing of the adhesive, for example, by crosslinking of the polymer chains. Due to the cured polymer matrix the reactive hot-melts do not soften upon heating and these adhesives are, therefore, suitable for use also at elevated temperatures. The chemical curing of the polymers can be initiated, for example, by heating or exposing the adhesive composition to water. Moisture curing hot-melt adhesives typically contain polymers functionalized with isocyanate or silane groups, which enable the crosslinking of the polymer chains upon contact with water, particularly with atmospheric moisture.

Typical reactive hot-melt adhesives used in the automotive industry as assembly adhesives include moisture curing polyurethane- and polyolefin-based hot melt adhesives. Moisture curing polyurethane hot-melt (PUR-RHM) adhesives consist mainly of isocyanate-terminated polyurethane prepolymers, which have been obtained by reacting suitable polyols, typically diols, with a stoichiometric excess of monomeric diisocyanates. When contacted with water the residual isocyanate groups of the polyurethane prepolymers form carbamic acid, which is unstable and decomposes into an amine and carbon dioxide. The amine reacts rapidly with other isocyanate groups to form urea linkages.

PU-RHM adhesives typically contain significant quantities of unreacted monomeric diisocyanates (“residual monomers”) since the isocyanate-functional prepolymers are obtained by reacting polyols with a significant stoichiometric excess of monomeric diisocyanates. The application temperature of hot-melt adhesives, such as from 85 to 200° C., particularly from 120 to 160° C., raises the vapor pressure of the residual monomers and causes them to volatilize. Due to the toxicity of certain diisocyanates, additional steps are often taken to reduce their atmospheric concentration in areas to which personnel are exposed. In some cases, ventilated structures such as “down draft booths” are provided to minimize personnel exposure to the volatilized monomers. However, providing such ventilated structures can be costly and difficult. Chemicals legislation and classification standards require products to be labeled as harmful (GHS07/GHS08) if the content of unreacted monomeric diisocyanates in the adhesive exceeds the limit of 0.1% by weight. At a concentration of monomeric MDI of >1%, moreover, products must be labeled with an additional hazard stamen (H351). For these reasons, various efforts have been made to reduce the concentration of residual diisocyanates in PU-RHM adhesives.

One obvious approach to provide a label-free PUR-RHM adhesive is to subject the reaction product obtained from reaction of diisocyanates and polyols to a physical unit operation, such as distillation or extraction step, to reduce the content of residual monomers. Methods based on this approach have been disclosed, for example, in WO 01/14443 A1 and WO 01/40340 A2. However, reducing the residual monomer content of a reaction product comprising polyurethane prepolymers obtained from the reaction of diisocyanates with amorphous polyols by distillation has turned out to be nearly impossible due to the high viscosity of such polyurethane prepolymers. On the other hand, amorphous polyols are typically required in a PUR-RHM adhesive, in addition to other types of polyols, to adjust various adhesive properties, particularly open time, green strength, viscosity, and flexibility of the cured adhesive.

Another approach is based on the use of distilled (stripped) short-chain polyurethane prepolymers having a low content of monomeric diisocyanates, which are commercially available, for example, under the trade name of Desmodur®, such as Desmodur® LS 2397 (from Covestro). Such stripped prepolymers can be used to replace a portion of the monomeric diisocyanates in the reaction mixture or as “a reactive diluent” to reduce the content of residual monomers of the final adhesive composition. These types of adhesive compositions have, however, been found to suffer from reduced heat resistance, inadequate storage stability, and decreased initial (green) adhesive strength.

Concentration of residual monomers can also be reduced by using a two-step production process comprising a first step of reacting a first type of polyol with diisocyanate monomers to provide a reaction mixture comprising a polyurethane prepolymer and residual monomers followed by a second step of adding another polyol to the reaction mixture to reduce the content of the residual monomers. One example of this approach has been disclosed in EP 3088435 A1. Another example is a three-step process disclosed in EP 3116930 A1, wherein polyols are first reacted with diisocyanate monomers to provide a reaction product, which is modified by the addition of mercaptosilanes. The amount of monomeric diisocyanates is then further reduced by addition of distilled polyurethane prepolymers before, during and/or after the addition of the mercaptosilanes. The approaches based on use of such step production processes have the inherent disadvantage of involving multiple reaction steps, which significantly increases the production costs.

There is thus a need for a novel type of reactive polyurethane hot-melt adhesive having a low content of residual monomers, which adhesive can be produced by using a simple and cost effective production process.

### SUMMARY OF THE INVENTION

The object of the present invention is to provide a moisture curing polyurethane hot-melt adhesive, which overcomes or at least mitigates the disadvantages of the prior art moisture curing polyurethane adhesives as discussed above.

Particularly, it is an object of the present invention to provide a H351 classification-free moisture curing polyurethane hot-melt adhesive.

Another objective of the present invention is to provide a H351 classification-free moisture curing polyurethane hot-melt adhesive having excellent adhesive bonding properties, particularly in terms of green (initial) strength, tensile strength, elongation, and heat resistance of the cured adhesive.

The subject of the present invention is an adhesive composition as defined in claim 1.

Two different approaches based on the same basic principle were identified for achieving the above stated goals. According to the first approach, at least one blocked amorphous polyester polyol is added as a non-reactive diluent to a reaction product comprising at least one isocyanate-functional polyurethane polymer having a low content of residual monomers to provide the adhesive with desired properties. Suitable isocyanate-functional polyurethane polymers having low content of residual monomers can be obtained by using low stoichiometric excess of isocyanate groups to hydroxyl groups in the reaction mixture or by using a high stoichiometric excess of isocyanate groups to hydroxyl groups followed by subjecting the reaction product to a treatment, such as distillation, to reduce the content of residual monomers.

The second approach is based on reacting polyurethane prepolymers having a low content of residual monomers with amorphous polyols to provide an adhesive composition having a low content of residual monomers and containing polyurethane prepolymers having the desired properties. Both aforementioned approaches enable providing moisture curing polyurethane hot-melt compositions having a very low content of residual monomers combined with good adhesive properties, especially in terms of green (initial) strength, tensile strength, elongation, and heat resistance of the cured adhesive. Furthermore, the present invention is not limited to use of only one of the aforementioned approaches and adhesive compositions based on a combination of both approaches are also considered to fall within the scope of the invention.

Other subjects of the present invention are presented in other independent claims. Preferred aspects of the invention are presented in the dependent claims.

### DETAILED DESCRIPTION OF THE INVENTION

The subject of the present invention is an adhesive composition comprising at least one isocyanate-functional polyurethane polymer PU,
wherein the at least one isocyanate-functional polyurethane polymer PU comprises:
   At least one isocyanate-functional polyurethane polymer PU1 obtained by reacting at least one polyester polyol PO1 and at least one diisocyanate P1 at a molar ratio of isocyanate groups to hydroxyl groups of 1.5-2.1, preferably 1.75-1.9 and/or
   At least one isocyanate-functional polyurethane polymer PU2 obtained by reacting at least one polyester polyol PO2 and at least one diisocyanate P2 at a molar ratio of at least 3, preferably at least 5 and subjecting the thus obtained reaction mixture to a treatment to reduce the amount of residual monomeric diisocyanates, preferably by distillation and
wherein the adhesive composition further comprises at least one acetylated amorphous polyester polyol APO
or wherein the at least one isocyanate-functional polyurethane polymer PU comprises:
   At least one isocyanate-functional polyurethane polymer PU3 obtained by reacting at least one polyester polyol PO3 and at least one polyurethane prepolymer PUP at a molar ratio of isocyanate groups to hydroxyl groups of 1.9-3.5, preferably 2.2-2.8 and
wherein the at least one polyester polyol PO3 comprises at least one amorphous polyester polyol PO31 and wherein the adhesive composition optionally further comprises at least one acetylated amorphous polyester polyol APO.

The prefix “poly” in substance designations such as “polyol” or “polyisocyanate” refers to substances which in formal terms contain two or more per molecule of the functional group that occurs in their designation. A polyol, for example, is a compound having two or more hydroxyl groups, and a polyisocyanate is a compound having two or more isocyanate groups.

The term “α-olefin” designates an alkene having the molecular formula CₓH₂ₓ (x corresponds to the number of carbon atoms), which features a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. For example, neither 1,3-butadiene, nor 2-butene, nor styrene are referred as “α-olefins” according to the present disclosure.

The term “prepolymer” designates a polymer, which contains at least one, usually two or more, reactive group(s), for example isocyanate groups. By way of the reactive groups, the prepolymer may be chain-extended, crosslinked or coupled.

The term “functionalized polymer” designates polymers which are chemically modified so as to contain a functional group on the polymer backbone. In contrast, the term “non-functionalized polymer” designates polymers which are not chemically modified so as to contain functional groups such as epoxy, silane, sulfonate, amide, or anhydride group on the polymer backbone.

The term “polyurethane polymer” designates polymers prepared by the so called diisocyanate polyaddition process. These also include those polymers which are virtually or entirely free from urethane groups. Examples of polyurethane polymers are polyether-polyurethanes, polyester-polyurethanes, polyether-polyureas, polyureas, polyester-polyureas, polyisocyanurates and polycarbodiimides.

The term “polyurethane prepolymer” designates polyurethane polymers comprising one or more unreacted isocyanate groups. The polyurethane prepolymers can be obtained by reacting excess of polyisocyanates with polyols and they are polyisocyanates themselves. The terms “isocyanate-functional polyurethane polymer” and “polyurethane prepolymer” can be used interchangeably.

An isocyanate is called “aliphatic” when its isocyanate group is directly bound to an aliphatic, cycloaliphatic or arylaliphatic moiety. The corresponding functional group is therefore called an aliphatic isocyanate group. Furthermore, an isocyanate is called “aromatic” when its isocyanate group is directly bound to an aromatic moiety. The corresponding functional group is therefore called an aromatic isocyanate group.

The term “molecular weight” refers to the molar mass (g/mol) of a molecule or a part of a molecule, also referred to as “moiety”. The term “average molecular weight” can refer to weight or number average molecular weight (Mₙ, M_{w}) of an oligomeric or polymeric mixture of molecules or moieties. The molecular weight can be determined by conventional methods, preferably by gel permeation-chromatography (GPC) using polystyrene as standard, styrene-divinylbenzene gel with porosity of 100 Angstrom, 1000 Angstrom and 10000 Angstrom as the column, and, depending on the molecule, tetrahydrofurane as a solvent, at 35° C., or 1,2,4-trichlorobenzene as a solvent, at 160° C.

The term “average OH-functionality” designates the average number of hydroxyl (OH) groups per molecule. The average OH-functionality of a compound can be calculated based on the number average molecular weight (Mₙ) and the hydroxyl number of the compound. The hydroxyl number of a compound can be determined by using method as defined in EN ISO 4629-2 standard.

The term “softening point” or “softening temperature” designates a temperature at which compound softens in a rubber-like state, or a temperature at which the crystalline portion within the compound melts. The softening point can be measured by a Ring and Ball method according to DIN EN 1238 standard.

The term “open time” designates the length of a time period during which an adhesive applied to a surface of a substrate is still able to form an adhesive bond after being contacted with another substrate.

The “amount or content of at least one component X” in a composition, for example “the amount of the at least one polyisocyanate P” refers to the sum of the individual amounts of all polyisocyanates P contained in the composition. Furthermore, in case the composition comprises 20 wt.-% of at least one polyisocyanate P, the sum of the amounts of all polyisocyanates P contained in the composition equals 20 wt.-%.

The term “room temperature” refers to a temperature of ca. 23° C.

The adhesive composition of the present invention preferably exhibits a low level of monomeric diisocyanates.

The term “monomeric diisocyanate” refers in the present disclosure to an organic compound with two isocyanate groups that are separated by a divalent hydrocarbon radical, preferably having an average molecular weight of not more than 1000 g/mol, more preferably not more than 500 g/mol, even more preferably not more than 400 g/mol. Particularly, a monomeric diisocyanate contains no urethane groups and oligomers or polymer products of diisocyanate monomers, such as adducts of monomeric diisocyanates, are not considered to be “monomeric diisocyanates” in the context of the present invention.

According to one or more embodiments, the adhesive composition has a content of monomeric diisocyanates of less than 1.0 wt.-%, preferably less than 0.85 wt.-%, more preferably less than 0.65 wt.-%, even more preferably less than 0.5 wt.-%, still more preferably less than 0.35 wt.-%, particularly less than 0.15 wt.-%, most preferably less than 0.1 wt.-%, based on the total weight of the adhesive composition. Adhesive compositions having content of monomeric diisocyanates of less than 0.1 wt.-% are safe to use even without special protective measures and can, therefore, be sold in many countries without being labeled as harmful (Xn).

Preferably, the at least one isocyanate-functional polyurethane polymer PU is present in the adhesive composition in an amount of at least 15 wt.-%, preferably at least 25 wt.-%, more preferably at least 35 wt.-%, even more preferably at least 40 wt.-%, based on the total weight of the adhesive composition.

According to one or more embodiments, the at least one isocyanate-functional polyurethane polymer PU is present in the adhesive composition in an amount of 15-85 wt.-%, preferably 25-75 wt.-%, more preferably 35-70 wt.-%, even more preferably 40-70 wt.-%, still more preferably 40-65 wt.-%, based on the total weight of the adhesive composition.

According to one or more embodiments, the at least one isocyanate-functional polyurethane polymer PU has an average isocyanate-functionality determined according to ISO 14896-2009 standard method A in the range of 1.2-2.7, preferably 1.5-2.5 and/or an isocyanate content determined by using the method as defined in ISO 11909:2007 standard in the range of 0.5-30 wt.-%, preferably 1.0-25 wt.-%.

Suitable compounds for use as the at least one acetylated amorphous polyester polyol APO can be obtained by acetylation of amorphous polyester polyols.

According to one or more embodiments, the at least one acetylated amorphous polyester polyol APO is obtained by a method comprising reacting at least one amorphous polyester polyol with acetic acid anhydride at a molar ratio of from 1.3:1 to 1:1.3, preferably from 1.1:1 to 1:1, preferably followed by subjecting the reaction product to distillation to reduce the amount of residual acetic acid anhydride. Preferably, the reaction of the at least one amorphous polyester polyol with acetic acid anhydride is conducted in a solution of acetic acid.

Preferably, the at least one acetylated amorphous polyester polyol APO, if used, is present in the adhesive composition in an amount of at least 5 wt.-%, preferably at least 10 wt.-%, more preferably at least 15 wt.-%, based on the total weight of the adhesive composition.

According to one or more embodiments, the at least one acetylated amorphous polyester polyol APO is present in the adhesive composition in an amount of 5-65 wt.-%, preferably 10-55 wt.-%, more preferably 10-50 wt.-%, even more preferably 15-45 wt.-%, still more preferably 20-45 wt.-%, based on the total weight of the adhesive composition.

Suitable polyester polyols for use in the present invention include, liquid, amorphous, partially crystalline, and crystalline polyester polyols. These can be obtained from by reacting dihydric and trihydric, preferably dihydric, alcohols, for example, 1,2-ethanediol, diethylene glycol, triethylene glycol, 1,2-propanediol, 1,3-propanediol, dipropylene glycol, 1,4-butanediol, 1,5-pentanediol, 1,6-hexanediol, 1,8-octanediol, 1,10-decanediol, 1,12-dodecanediol, dimer fatty alcohol, neopentyl glycol, glycerol, 1,1,1-trimethylolpropane or mixtures of the aforesaid alcohols, with organic dicarboxylic acids or tricarboxylic acids, preferably dicarboxylic acids, or their anhydrides or esters, such as succinic acid, glutaric acid, 3,3-dimethylglutaric acid, adipic acid, suberic acid, sebacic acid, undecanedioic acid, dodecanedicarboxylic acid, azelaic acid, maleic acid, fumaric acid, phthalic acid, dimer fatty acid, isophthalic acid, terephthalic acid, and hexahydrophthalic acid, or mixtures of the aforesaid acids, and also polyester polyols made from lactones such as from ε-caprolactone, for example, also known as polycaprolactones.

Preferred polyester polyols include those obtained by reacting adipic acid, sebacic acid or dodecanedicarboxylic acid as dicarboxylic acid and hexanediol or neopentyl glycol as dihydric alcohol. Further examples of suitable polyester polyols include polyester polyols of oleochemical origin. Polyester polyols of this type may be prepared, for example, by complete ring opening of epoxidized triglycerides of a fat mixture comprising at least partially olefinically unsaturated fatty acids, with one or more alcohols having 1-12 carbon atoms, and by subsequent partial transesterification of the triglyceride derivatives to give alkyl ester polyols having 1-12 carbon atoms in the alkyl radical. Particularly suitable crystalline or semicrystalline polyester polyols include adipic acid/hexanediol polyester and dodecanedicarboxylic acid/hexanediol polyesters.

According to one or more embodiments, the at least one isocyanate-functional polyurethane polymer PU comprises:
At least one isocyanate-functional polyurethane polymer PU1 obtained by reacting at least one polyester polyol PO1 and at least one diisocyanate P1 at a molar ratio of isocyanate groups to hydroxyl groups of 1.5-2.1, preferably 1.75-1.9 and/or
At least one isocyanate-functional polyurethane polymer PU2 obtained by reacting at least one polyester polyol PO2 and at least one diisocyanate P2 at a molar ratio of at least 3, preferably at least 5 and subjecting the thus obtained reaction mixture to a treatment to reduce the amount of residual monomeric diisocyanates, preferably by distillation.

The reaction between the at least one polyester polyol PO1 and the at least one diisocyanate P1 can be conducted using conventional techniques used for preparation of polyurethane prepolymers. This means particularly that the hydroxyl groups of the polyester polyol PO1 react with the isocyanate groups of the diisocyanate P1.

Preferably, the reaction between the at least one polyester polyol PO1 and the at least one diisocyanate P1 will convert substantially all the hydroxyl groups of the at least one polyester polyol PO1, for example at least 95%, generally at least 99%, of the hydroxyl groups of the at least one polyester polyol PO1.

The reaction between the at least one polyester polyol PO1 and the at least one diisocyanate P1 may, for example, be carried out at temperatures in the range of 60-160° C., preferably 80-140° C., optionally in the presence of a catalyst. The reaction time, as will be appreciated, depends on the temperature employed, but may, for example, be in the range of from 30 minutes to 6 hours, preferably from 30 minutes to 3 hours, more preferably from 30 minutes to 1.5 hours. Suitable catalysts include, for example, metal catalysts, such as Coscat®83 (from Vertellus Performance Materials Inc.), and tin catalysts.

Analogous considerations apply to the reactions between the at least one polyester polyol PO2 and the at least one diisocyanate P2.

According to one or more embodiments, the at least one polyester polyol PO1 comprises at least one at 23° C. solid polyester polyol PO11 and/or at least one at 23° C. liquid polyester polyol PO12.

Generally, the expression “the at least one component X comprises at least one component XN”, such as “the at least one polyester polyol PO1 comprises at least one solid polyester polyol PO11” is understood to mean in the context of the present disclosure that the composition comprises one or more solid polyester polyols PO11 as representatives of the at least one polyester polyol PO1.

Preferably, the at least one at 23° C. solid polyester polyol PO11 is a at 23° C. solid crystalline polyester polyol, preferably having:
a hydroxyl number measured according to EN ISO 4629-2 standard of 10-100 mg KOH/g, preferably 15-50 mg KOH/g and/or
a softening point measured by Ring and Ball method according to ISO 4625 standard of 50-100° C., preferably 60-90° C. and/or
a number average molecular weight (Mₙ) of 500-10000 g/mol, preferably 1500-7500 g/mol.

Suitable solid polyester polyols for use as the polyester polyol PO11 are commercially available under the trade name of 7300-series (from Evonik Industries).

Preferably, the at least one at 23° C. liquid polyester polyol PO12 has:
a hydroxyl number measured according to EN ISO 4629-2 standard of 10-100 mg KOH/g, preferably 15-50 mg KOH/g and/or
a glass transition temperature measured by DCS of at or below −10° C., preferably at or below −25° C. and/or
a number average molecular weight (Mₙ) of 500-10000 g/mol, preferably 1500-7500 g/mol.

Suitable liquid polyester polyols for use as the polyester polyol PO12 are commercially available under the trade name of 7200-series (from Evonik Industries) and under the trade name of Fineplus® HM (from DIC Performance Resins), such as Fineplus® HM 2686.

According to one or more preferred embodiments, the at least one polyester polyol PO1 comprises the at least one at 23° C. solid polyester polyol PO11 and the at least one at 23° C. liquid polyester polyol PO12, wherein the weight ratio of the total amount of PO12 to the total amount of PO11 is preferably in the range of from 5:1 to 1:5, more preferably from 3:1 to 1:3, even more preferably from 2:1 to 1:2, still more preferably from 1.5:1 to 1:1.5.

Especially suitable diisocyanates for use as the at least one diisocyanate P1 and P2 include, for example, monomeric aliphatic, cyclo-aliphatic, and aromatic diisocyanates.

According to one or more preferred embodiments, the at least one diisocyanate P1 and P2 are monomeric diisocyanates, preferably monomeric diisocyanates having a number average molecular weight (Mₙ) of not more than 1000 g/mol, preferably not more than 500 g/mol, more preferably not more than 400 g/mol.

Examples of suitable monomeric diisocyanates include aliphatic and aromatic monomeric diisocyanates, for example, 1,6-hexamethylene diisocyanate (HDI), 2-methylpentamethylene 1,5-diisocyanate, 2,2,4- and 2,4,4-trimethyl-1,6-hexamethylene diisocyanate (TMDI) and mixtures of these isomers, 1,10 decamethylene diisocyanate, 1,12-dodecamethylene diisocyanate, lysine diisocyanate, lysine ester diisocyanate, cyclohexane 1,3-diisocyanate and cyclohexane 1,4-diisocyanate and mixtures of these isomers, 1-methyl-2,4-and-2,6-diisocyanatocyclohexane and mixtures of these isomers (HTDI or H6TDI), 1-isocyanato-3,3,5-trimethyl-5-isocyanatomethylcyclohexane (=isophoronediisocyanate or IPDI), perhydro-2,4′- and -4,4′-diphenylmethane diisocyanate (HMDI or H12MDI) and mixtures of these isomers, 1,4-diisocyanato-2,2,6-trimethylcyclohexane (TMCDI), 1,3- and 1,4-bis(isocyanato-methyl)cyclohexane, m- and p-xylylene diisocyanate (m- and p-XDI) and mixtures of these isomers, m- and p-tetramethyl-1,3- and 1,4-xylylene diisocyanate (m- and p-TMXDI) and mixtures of these isomers, bis(1-isocyanato-1-methylethyl) naphthalene, 2,4- and 2,6-tolylene diisocyanate and mixtures of these isomers (TDI), 4,4′-diphenylmethane diisocyanate, optionally with proportions of 2,4′- and/or 2,2′-diphenylmethane diisocyanate (MDI), 1,3- and 1,4-phenylene diisocyanate (PDI) and mixtures of these isomers, naphthalene 1,5-diisocyanate (NDI), 3,3′-dimethyl-4,4′-diisocyanatobiphenyl (TODI), and dianisidine diisocyanate (DADI).

Suitable aliphatic and aromatic monomeric diisocyanates are commercially available, for example, under the trade names of Lupranat® (from BASF), Desmodur (from Covestro), and Duranate® (from Asahi Kasei).

According to one or more embodiments, the at least one diisocyanate P1 and P2 are selected from the group consisting of 4,4′-diphenylmethane diisocyanate (4,4′-MDI), 2,4′-diphenylmethane diisocyanate (2,4′-MDI), 2,2′-diphenylmethane diisocyanate (2,2′ MDI), or mixtures of these isomers, tolylene diisocyanate (TDI), in particular 2,4-tolylene diisocyanate (2,4 TDI), 2,6-tolylene diisocyanate (2,6 TDI), or mixtures of these isomers, 1,6-hexamethylene diisocyanate (HDI), and 1-isocyanato-3,3,5-trimethyl-5-isocyanatomethylcyclohexane (IPDI). Furthermore, a person skilled in the art knows that the technical grade products of diisocyanates may frequently contain isomer mixtures or other isomers as impurities.

According to one or more embodiments, the isocyanate-functional polyurethane polymer PU2 has a content of monomeric diisocyanates of not more than 1.0 wt.-%, preferably not more than 0.5 wt.-%, based on the total weight of the isocyanate-functional polyurethane polymer.

According to one or more embodiments, the at least one isocyanate-functional polyurethane polymer PU2 comprises:
At least one first isocyanate-functional polyurethane polymer PU21 obtained by reacting at least one polyester polyol PO21 and the at least one diisocyanate P2 and/or
At least one second isocyanate-functional polyurethane polymer PU22 obtained by reacting at least one polyester polyol PO22 and the at least one diisocyanate P2,
wherein the at least one polyester polyol PO21 is a at 23° C. solid polyester polyol and the at least one polyester polyol PO22 is a at 23° C. liquid polyester polyol.

According to one or more embodiments, the at least one polyester polyol PO21 has:
a hydroxyl number measured according to EN ISO 4629-2 standard of 10-100 mg KOH/g, preferably 15-50 mg KOH/g and/or
a softening point measured by Ring and Ball method according to ISO 4625 standard of 45-100° C., preferably 55-90° C. and/or
a number average molecular weight (Mₙ) of 500-10000 g/mol, preferably 1500-7500 g/mol.

According to one or more embodiments, the at least one polyester polyol PO22 has:
a hydroxyl number measured according to EN ISO 4629-2 standard of 10-100 mg KOH/g, preferably 15-50 mg KOH/g and/or
a glass transition temperature measured by DCS of at or below −10° C., preferably at or below −25° C. and/or
a number average molecular weight (Mₙ) of 500-10000 g/mol, preferably 1500-7500 g/mol.

According to one or more embodiments, the at least one isocyanate-functional polyurethane polymer PU2 comprises the at least one isocyanate-functional polyurethane polymer PU21 and the at least one isocyanate-functional polyurethane polymer PU22, wherein the weight ratio of the total amount of polymer PU21 to the total amount of polymer PU22 is preferably in the range of from 10:1 to 1:1, more preferably from 7:1 to 1.5:1, even more preferably from 5:1 to 2:1, still more preferably from 5:1 to 3:1.

According to one or more embodiments, the at least one diisocyanate P2 comprises at least one diisocyanate P21 and/or at least one diisocyanate P22, wherein the at the at least one diisocyanate P21 is a monomeric diphenylmethane diisocyanate having a 2,4′-isomer content of at least 25 wt.-%, preferably at least 35 wt.-%, based on the total weight of the first diisocyanate P21 and wherein the at least one second diisocyanate P22 is a monomeric diphenylmethane diisocyanate having a 4,4′-isomer content of at least 75 wt.-%, preferably at least 95 wt.-%, based on the total weight of the second diisocyanate P22.

According to one or more embodiments, the at least one diisocyanate P2 comprises or is composed of the at least one diisocyanate P21. According to one or more embodiments, the at least one diisocyanate P2 comprises or is composed of the at least one diisocyanate P22.

According to one or more preferred embodiments, the at least one diisocyanate P2 is composed of the at least one diisocyanate P22.

According to one or more embodiments, the at least one isocyanate-functional polyurethane polymer PU comprises:
At least one isocyanate-functional polyurethane polymer PU3 obtained by reacting at least one polyester polyol PO3 and at least one polyurethane prepolymer PUP at a molar ratio of isocyanate groups to hydroxyl groups of 1.9-3.5, preferably 2.2-2.8, wherein the at least one polyester polyol PO3 comprises at least one amorphous polyester polyol PO31.

According to one or more embodiments, the isocyanate-functional polyurethane polymer PU3 has a content of monomeric diisocyanates of not more than 1.0 wt.-%, preferably not more than 0.5 wt.-%, based on the total weight of the isocyanate-functional polyurethane polymer PU3.

Preferably, the at least one amorphous polyester polyol PO31 has:
a hydroxyl number measured according to EN ISO 4629-2 standard of 15-100 mg KOH/g, preferably 25-75 mg KOH/g and/or
a softening point measured by Ring and Ball method according to ISO 4625 standard of 55-115° C., preferably 65-105° C. and/or
a number average molecular weight (Mₙ) of 500-10000 g/mol, preferably 1500-7500 g/mol and/or
a glass transition temperature measured by DCS of at least 0° C., preferably at least 15° C., more preferably at least 25° C.

Suitable polyester polyols for use as the at least one amorphous polyester polyol PO31 are commercially available, for example, under the trade name of Dynacoll® 7100-series (from Evonik Industries) and under the trade name of Fineplus® HM 1800 series (from DIC Performance Resins).

According to one or more preferred embodiments, the at least one polyester polyol PO3 comprises the at least one amorphous polyester polyol PO31 and at least one at 23° C. solid crystalline polyester polyol PO32.

Preferably, the at least one at 23° C. solid crystalline polyester polyol PO32 has:
a hydroxyl number measured according to EN ISO 4629-2 standard of 10-100 mg KOH/g, preferably 15-50 mg KOH/g and/or
a softening point measured by Ring and Ball method according to ISO 4625 standard of 45-100° C., preferably 55-90° C. and/or
a number average molecular weight (Mₙ) of 500-10000 g/mol, preferably 1500-7500 g/mol.

Preferably, the at least one polyurethane prepolymer PUP is obtained by reacting at least one polyester polyol PO4 and the at least one diisocyanate P2 at a molar ratio of at least 3, preferably at least 4 and subjecting the thus obtained reaction mixture to a treatment to reduce the amount of residual monomeric diisocyanates, preferably by distillation.

According to one or more embodiments, the polyurethane prepolymer PUP has a content of monomeric diisocyanates of not more than 1.0 wt.-%, preferably not more than 0.5 wt.-%, based on the total weight of the polyurethane prepolymer PUP.

Especially suitable polyester polyols for use as the at least one polyester polyol PO4 include liquid polyester polyols as well as partially crystalline, and crystalline polyester polyols, which are solid at a temperature of 23° C.

According to one or more preferred embodiments, the at least one polyester polyol PO4 comprises or is composed of poly(tetramethylene ether)glycol, preferably having a number average molecular weight (Mₙ) of 250-10000 g/mol, preferably 500-7500 g/mol.

According to one or more embodiments, the at least one isocyanate-functional polyurethane polymer PU comprises the least one isocyanate-functional polyurethane polymer PU2 and the at least one isocyanate-functional polyurethane polymer PU3, wherein the weight ratio of the total amount of the polyurethane polymer PU2 to the total amount of the polyurethane polymer PU3 is preferably in the range of 5:1 to 1:5, more preferably 3:1 to 1:3, even more preferably 2:1 to 1:2.

According to one or more further embodiments, the at least one isocyanate-functional polyurethane polymer PU comprises the least one isocyanate-functional polyurethane polymer PU2 and the at least one isocyanate-functional polyurethane polymer PU3, wherein the weight ratio of the total amount of the polyurethane polymer PU2 to the total amount of the polyurethane polymer PU3 is preferably in the range of 5:1 to 1:5, more preferably 3:1 to 1:3, even more preferably 2:1 to 1:2 and wherein the adhesive composition further comprises the at least one acetylated polyester polyol APO.

According to one or more embodiments, the adhesive composition further comprises at least one further thermoplastic polymer TP without isocyanate groups.

Suitable compounds for use as the at least one further thermoplastic polymer TP include, for example, thermoplastic polyurethanes (TPU) and thermoplastic polyester resins.

Thermoplastic polyurethanes (TPU) are polyurethane-based thermoplastic elastomers (TPE) that are linear segmented block copolymers composed of alternating hard and soft segments or domains formed by the reaction of (1) diisocyanates with short-chain diols (so-called chain extenders) and (2) diisocyanates with long-chain diols.

Suitable thermoplastic polyester resins include, for example, polyester resins having a hydroxyl number measured according to EN ISO 4629-2 of not more than 15 mg KOH/g, preferably not more than 12 mg KOH/g and/or a number average molecular weight (Mₙ) of at least 5000 g/mol, preferably at least 7500 g/mol.

According to one or more embodiments, the at least one further thermoplastic polymer TP comprises at least one thermoplastic polyurethane, preferably a polycaprolactone-copolyester polyurethane, and/or at least one thermoplastic polyester resin, preferably having a hydroxyl number measured according to EN ISO 4629-2 of not more than 15 mg KOH/g, preferably not more than 12 mg KOH/g.

According to one or more embodiments, the at least one further thermoplastic polymer TP is present in the adhesive composition in an amount of 0.5-30 wt.-%, preferably 2.5-25 wt.-%, more preferably 3.5-20 wt.-%, based on the total weight of the adhesive composition.

According to one or more embodiments, the adhesive composition further comprises at least one crosslinking agent, preferably an oligomeric polyisocyanate.

According to one or more embodiments, the at least one crosslinking agent has:
a number average molecular weight (Mₙ) of 150-5000 g/mol, preferably 250-3500 g/mol, more preferably 350-2500 g/mol, even more preferably 350-1500 g/mol and/or
a viscosity measured at 23° C. according to ISO 3219:1994 standard of 100-5000 MPa·s, preferably of 250-4000 MPa·s, more preferably 350-3500 MPa·s, even more preferably of 450-2500 MPa·s, still more preferably 500-2000 MPa·s and/or
a content of free NCO groups measured according to ISO 11909:2007 standard of 10-35 wt.-%, preferably 15-30 wt.-%, more preferably 20-30 wt.-%.

According to one or more embodiments, the at least one crosslinking agent is an aliphatic or aromatic oligomeric polyisocyanate.

According to one or more embodiments, the at least one crosslinking agent is a trimer of an aliphatic diiosocyanate, preferably selected from the group consisting of hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, cyclohexane 1,3- and 1,4-diisocyanate and any desired mixtures of these isomers, 1-isocyanato-3,3,5-trimethyl-5-isocyanatomethylcyclohexane (IPDI), perhydrodiphenylmethane 2,4′- and 4,4′-diisocyanate (HMDI), 1,4-diisocyanato-2,2,6-trimethylcyclohexane (TMCDI), xylylene m- and p-diisocyanate (XDI), tetramethylxylylene 1,3- and 1,4-diisocyanate (TMXDI), and 1,3 and 1,4-bis(isocyanatomethyl)cyclohexane.

Technical forms of trimers of an aliphatic diiosocyanates are typically mixtures of substances having different degrees of polymerization and chemical structures. Suitable commercially available trimers of aliphatic diisocyanates include technical oligomer mixtures having an average NCO-functionality of from 2,4 to 4.0 and containing, in particular, isocyanurate, iminooxadiazinedione or biuret groups. In addition, there may also be allophanate, carbodiimide, uretonimine or oxadiazinetrione groups present. Preferred technical form of trimers of aliphatic diisocyanates are oligomer mixtures comprising a major portion of trimers of aliphatic diisocyanates in a mixture with dimers and higher oligomers. Especially preferred are oligomer mixtures comprising low amount of monomeric diisocyanates, in particular having a content of monomeric diisocyanates of not more than 1.0 wt.-%, preferably not more than 0.5 wt.-%, even more preferably not more than 0.25 wt.-%, still more preferably not more than 0.25 wt.-%.

Suitable commercially available technical oligomer mixtures of aliphatic diisocyanates are HDI biurets, for example Desmodur® N 100 and N 3200 (from Coverstro), Tolonate® HDB and HDB-LV (from Vencorex) and Duranate® 24A-100 (from Asahi Kasei); HDI isocyanurates, for example Desmodur® N 3300, N 3600 and N 3790 BA (all from Coverstro), Tolonate® HDT, HDT-LV and HDT-LV2 (all from Vencorex), Duranate® TPA-100 and THA-100 (from Asahi Kasei) and Coronate® HX (from Nippon Polyurethanes); HDI uretdiones, for example as Desmodur® N 3400 (from Covestro); HDI iminooxadiazinediones, for example as Desmodur® XP 2410 (from Coverstro); HDI allophanates, for example as Desmodur® VP LS 2102 (form Covestro); and IPDI isocyanurates, for example in solution such as Desmodur® Z 4470 (from Covestro) or in solid form as Vestanat® T1890/100 (from Evonik Degussa).

According to one or more embodiments, the at least one crosslinking agent is present in the adhesive composition in an amount of 0.1-10 wt.-%, preferably 0.5-5 wt.-%, based on the total weight of the adhesive composition.

The adhesive composition can further comprise auxiliary substances and additives, for example, those selected from the group consisting of fillers, flame retardants, plasticizers, adhesion promoters, UV absorption agents, UV and heat stabilizers, optical brighteners, pigments, dyes, and desiccants. Examples of suitable UV stabilizers that can be added to the adhesive composition include, for example, sterically hindered phenols.

Suitable fillers for use in the adhesive composition include, for example, inorganic and organic fillers, especially natural, ground or precipitated calcium carbonates, optionally coated with fatty acids or fatty acid esters, especially stearic acid, baryte (heavy spar), talcs, quartz flours, quartz sand, dolomites, wollastonites, kaolins, calcined kaolins, mica (potassium aluminum silicate), molecular sieves, aluminum oxides, aluminum hydroxides, magnesium hydroxide, silicas including finely divided silicas from pyrolysis processes, industrially produced carbon blacks, graphite, metal powders such as aluminum, copper, iron, silver or steel, PVC powder or hollow spheres.

According to one or more embodiments, the adhesive composition further comprises at least one inorganic filler, preferably selected from calcium carbonate, baryte, talc, quartz flour, quartz sand, dolomite, wollastonite, kaolin, calcined kaolin, mica, molecular sieves, aluminum oxide, aluminum hydroxide, magnesium hydroxide, silica, carbon black, graphite, metal powder, and hollow sphere.

The at least one inorganic filler, if used, is preferably present in the adhesive composition in an amount of 1.5-35 wt.-%, more preferably 2.5-30 wt.-%, more preferably 5-25 wt.-%, even more preferably 5-20 wt.-%, based on the total weight of the adhesive composition.

According to one or more embodiments, the adhesive composition further comprises at least one at 23° C. liquid polyolefin resin. Preferably, the at least one at 25° C. liquid polyolefin resin is a at 25° C. liquid non-functionalized polyolefin resin.

According to one or more embodiments, the at least one at 23° C. liquid polyolefin resin is present in the adhesive composition in an amount of 1-30 wt.-%, preferably 5-25 wt.-%, more preferably 10-25 wt.-%, based on the total weight of the adhesive composition.

According to one or more embodiments, the at least one at 23° C. liquid polyolefin resin has:
a number average molecular weight (Mₙ) in the range of 500-5000 g/mol, preferably 500-3500 g/mol, more preferably 1000-3000 g/mol, more preferably 1500-2500 g/mol and/or
a pour point determined according to ISO 3016 standard in the range of −10 to +15° C., preferably from −10 to +10° C.

According to one or more embodiments, the at least one at 23° C. liquid polyolefin resin is selected from a group consisting of polyisobutylene (PIB) and polybutene, particularly low molecular weight polyisobutylene and low molecular weight polybutene, preferably having a number average molecular weight (Mₙ) in the range of 500-5000 g/mol, more preferably 500-3500 g/mol, even more preferably 1000-3000 g/mol, still more preferably 1500-2500 g/mol and/or a pour point determined according to ISO 3016 standard in the range of −10 to +15° C., preferably from −10 to +10° C. The term “polyisobutylene” refers in the present document to polyolefins and olefin oligomers of isobutylene or 2-methyl-1-propene, preferably containing at least 75%, more preferably at least 85% of repeat units derived from isobutylene. The term “polybutene” refers in the present document to polyolefins and olefin oligomers comprising isobutylene and/or 1-butene and/or 2-butene. The ratio of the C₄-olefin isomers can vary by manufacturer and by grade. When the C₄-olefin is exclusively 1-butene, the material is referred to as “poly-n-butene” or “PNB”.

Suitable commercially available at 23° C. liquid polybutenes and polyisobutylenes include, for example, Indopol® H-300 and Indopol® H-1200 (from Ineos); Glissopal® V230, Glissopal® V500, and Glissopal® V700 (from BASF); Dynapak® poly 230 (from Univar GmbH, Germany); and Daelim® PB 950 (from Daelim Industrial).

The adhesive composition may further comprise one or more catalysts, which are used to accelerate the reaction of the isocyanate groups with moisture. The presence of such catalysts is not mandatory, but it may be preferred. Examples of suitable catalysts include metal-based catalysts such as dialkyltin complexes, particularly dibutyltin (IV) or dioctyltin (IV) carboxylates or acetoacetonates, such as dibutyltindilaurate (DBTDL), dibutyltindiacetylacetonate, dioctyltindilaurate (DOTDL), further bismuth (III) complexes such as bismuthoctoate or bismuthneodecanoate, zinc (II) complexes, such as zincoctoate or zincneodecanoate, and zirconium (IV) com-plexes, such as zirconiumoctoate or zirconiumneodecanoate.

Further examples of suitable catalysts include compounds containing amine groups such as, dimorpholinodialkylethers and/or dimorpholino substituted polyalkylene glycols, for example 2,2′-dimorpholinodiethyl ether and 1,4-diazabicyclo[2.2.2]-octane. Combinations of two or more catalysts may also be used, preferred ones including combinations of one or more metal-catalysts with one or more morpholine amine compounds.

The total amount of catalysts catalyzing the reactions of isocyanate groups with moisture, if present in the adhesive composition, is preferably 0.005-2.00 wt.-%, more preferably 0.05-1.00 wt.-%, based on the total weight of the adhesive composition.

The adhesive composition is a moisture-curing adhesive composition, i.e., the adhesive composition can be cured by contacting the composition with water, especially with atmospheric moisture. Preferably, the adhesive composition is a moisture curing hot-melt adhesive composition.

Furthermore, the adhesive composition of the present invention has good workability under typical application conditions of hot-melt adhesives, particularly at temperatures in the range of 100-180° C., meaning that at the application temperature the adhesive has sufficiently low viscosity to enable application to a substrate in a molten state. The adhesive composition also develops a high initial strength immediately after the application to a substrate upon cooling even before the initiation of the crosslinking reaction with water, particularly with atmospheric moisture.

According to one or more embodiments, the adhesive composition has a viscosity at a temperature of 130° C. of not more than 100000 mPa·s, preferably not more than 85000 mPa's, more preferably not more than 75000 mPa·s and/or a viscosity at a temperature of 130° C. of at least 10000 mPa·s, preferably at least 12500 mPa·s, more preferably at least 15000 mPa·s. The viscosity at temperature of 130° C. can be measured using conventional viscometers at 5 revolutions per minute, for example by using a Brookfield DV-2 Thermosel viscometer with a spindle No. 27.

According to one or more embodiments, the adhesive composition has a softening point measured by Ring and Ball method according to DIN EN 1238 standard in the range of 60-150° C., preferably 65-140° C., more preferably 70-130° C., even more preferably 75-115° C.

Furthermore, the adhesive composition can be provided as a one-component storage-stable composition. According to one or more embodiments, the adhesive composition is a one-component moisture curing hot-melt adhesive composition. The term “storage-stable composition” refers in the present document to a composition which, particularly in the absence of moisture, can be kept in a suitable package(s) or facility, such as a drum, a pouch or a cartridge, for example, for a period of several months up to one year or more, without suffering any service-relevant change in the application properties and/or reactivity of the composition.

The preferences given above for the isocyanate-functional polyurethane polymers PU, PU1, PU2, and PU3, to the polyester polyols PO1, PO2, PO3, and PO4, to the diisocyanates P1, and P2, and to the polyurethane prepolymer PUP apply equally to all subjects of the present invention unless stated otherwise.

Another subject of the present invention is a method for producing an adhesive composition of the present invention comprising mixing of the at least one isocyanate-functional polymer PU with other constituents of the adhesive composition.

The mixing of the at least one isocyanate-functional polymer PU with the other constituents of the adhesive composition is preferably conducted at a temperature, which is above the softening point of the at least one isocyanate-functional polymer PU. According to one or more embodiments, the mixing is conducted at a temperature in the range of 50-200° C., preferably 65-180° C., more preferably 80-175° C., even more preferably 90-160° C.

Another subject of the present invention is use of the adhesive composition of the present invention as an assembly adhesive, a laminating adhesive, or as an adhesive for the building of sandwich elements.

Still another subject of the present invention is a method for adhesively bonding a first substrate to a second substrate, the method comprising steps of:
I) Heating an adhesive composition according to the present invention to provide a melted adhesive composition,
II) Applying the melted adhesive composition to a surface of the first substrate to form an adhesive film,
III) Contacting the adhesive film with a surface of the second substrate, and
IV) Chemically curing the adhesive film with water, particularly with atmospheric moisture.

The first and second substrates are preferably sheet-like articles having first and second major surfaces defined by peripheral edges and defining a thickness there between or three-dimensional shaped articles.

In the method for adhesively bonding a first substrate to a second substrate, the adhesive composition is heated to a temperature above the softening point of the adhesive composition and applied on the surface of the first substrate in molten state using any conventional technique, for example, by using slot die coating, roller coating, extrusion coating, calendar coating, or spray coating. The adhesive composition can be applied to the surface of the first substrate with a coating weight of, for example, 50-500 g/m², such as 55-350 g/m², particularly 65-150 g/m².

Especially in case the adhesive composition is applied to the surface of the first substrate as a thin film having a coating weight of, for example, less than 150 g/m², particularly less than 100 g/m², the adhesive film formed in step II) may be reactivated by heating before being contacted with the surface of the second substrate. The reactivation temperature depends on the embodiment of the adhesive composition. It may be preferable, for example, that the adhesive film is reactivated by heating to a temperature of 60-200° C., particularly 70-180° C., preferably 120-160° C. The heating of the adhesive film can be conducted using any conventional techniques, such as heating in an oven, heating by air stream, or heating with infrared (IR)-radiation. The reactivated adhesive film is preferably contacted with the second substrate within short time after the reactivation temperature is reached, in any case within the open time of the adhesive composition.

After the adhesive film has been contacted with the surface of the second substrate, the adhesive composition develops a certain initial adhesive strength by physical curing, i.e., upon cooling. Depending on the application temperature and on the embodiment of the adhesive composition, particularly on the reactivity of the adhesive, the chemical curing reactions may begin already during the application of the adhesive composition on the surface of the first substrate. Typically, however, major part of the chemical curing occurs after the application of adhesive, particularly, after the applied adhesive film has been contacted with the surface of the second substrate.

The first and second substrates can be composed of any conventional material including polymeric material, metal, painted metal, glass, wood, wood derived materials such as natural fiber polypropylene (NFPP), and fiber materials. Suitable polymeric materials include, for example, polyethylene (PE), particularly high density polyethylene (HDPE), polypropylene (PP), glass-fiber reinforced polypropylene (GFPP), polyvinyl chloride (PVC), polyethylene terephthalate (PET), polystyrene (PS), polycarbonate (PC), polymethylmethacrylate (PMMA), acrylonitrile butadiene styrene (ABS), polyamide (PA), and combinations thereof. The first and second substrates can be composed of a single layer or of multiple layers of different types of materials. The layer(s) composed of polymeric materials can further contain additives such as fillers, plasticizers, flame retardants, thermal stabilizers, antioxidants, pigments, dyes, and biocides.

According to one or more embodiments, one of the first and second substrates is composed of a polar material, wherein the other substrate is composed of a non-polar material.

According to one or more further embodiments, the first substrate, or in case the first substrate is composed of multiple layers, the layer constituting the outer exterior surface on which the adhesive composition is applied in step II) of the method, is composed of a polar material, preferably selected from the group consisting of PMMA, PA, PC, ABS, glass fiber reinforced plastic (GFRP), glass, and metal and the second substrate, or in case the second substrate is composed of multiple layers, the layer constituting the outer exterior surface, which is contacted with the adhesive film in step III) of the method, is composed of a non-polar material, preferably selected from the group consisting of polypropylene, polyethylene, and polystyrene.

According to one or more further embodiments, the first substrate, or in case the first substrate is composed of multiple layers, the layer constituting the outer exterior surface on which the adhesive composition is applied in step II) of the method, is composed of a non-polar material, preferably selected from the group consisting of polypropylene, polyethylene, or polystyrene and the second substrate, or in case the second substrate is composed of multiple layers, the layer constituting the outer exterior surface which is contacted with the adhesive film in step III) of the method, is composed of a polar material, preferably selected from the group consisting of PMMA, PA, PC, ABS, glass fiber reinforced plastic (GFRP), glass, or metal

Still another subject of the present invention is a composite element obtainable by using the method for adhesively bonding a first substrate to a second substrate of the present invention.

The composite element of the present invention can be used, for example, for producing interior lining components of automotive vehicles. Examples of such interior lining components include door panel pieces, switch panels, rear parcel shelves, head liners, sliding roofs, center consoles, glove compartments, sun visors, pillars, door handles, arm rests, flooring, cargo flooring, and trunk area flooring as well as sleeping cabins and rear panels of trucks.

### Examples

The followings compounds and products shown in Table 1 were used in the examples.

TABLE 1

| | |
|---|---|
| PO11 | Solid, highly crystalline saturated copolyester, softening point |
| | (DIN ISO 4625) 70-80° C. |
| PO12 | Liquid linear copolyester, glass transition temperature |
| | (DSC) −35-−25° C. |
| PO13 | Solid, saturated amorphous copolyester, glass transition |
| | temperature (DSC) 40-55° C. |
| PO21 | Solid, partially crystalline saturated copolyester, softening point |
| | (DIN ISO 4625) 60-70° C. |
| PO22 | Liquid saturated copolyester, glass transition temperature |
| | (DSC) −50-−40° C. |
| PO23 | Solid, highly crystalline saturated copolyester, softening point |
| | (DIN ISO 4625) 70-80° C. |
| PO31 | Solid, saturated amorphous copolyester, glass transition |
| | temperature (DSC) 30-40° C. |
| PO32 | Solid, saturated amorphous copolyester, glass transition |
| | temperature (DSC) 40-50° C. |
| PO33 | Solid, saturated amorphous copolyester, glass transition |
| | temperature (DSC) 30-40° C. |
| PO34 | Solid, saturated amorphous copolyester, glass transition |
| | temperature (DSC) 40-50° C. |
| PO35 | Solid, highly crystalline saturated copolyester, softening point |
| | (DIN ISO 4625) 70-80° C. |
| PO36 | Solid, partially crystalline saturated copolyester, softening point |
| | (DIN ISO 4625) 60-70° C. |
| PO4 | Poly(tetramethylene ether)glycol |
| P1 | 4,4′-Diphenylmethandiisocyanate (2,4′-MDI isomer content max. 1.5%) |
| P21 | 4,4′-Diphenylmethandiisocyanate (2,4′-MDI isomer content max. 2%) |
| P22 | 2,4-Diphenylmethandiisocyanate (2,4′-MDI isomer content 50-60%) |
| TP1 | Thermoplastic polyurethane, melting point 60-70° C. |
| TP2 | Thermoplastic polyurethane, melting point 70-80° C. |
| TP3 | Saturated linear copolyester, number average molecular weight |
| | (Mₙ) 20000-25000 g/mol, glass transition temperature (DSC) 50- |
| | 60° C. |
| TP4 | Saturated linear copolyester, softening point (DIN ISO 4625) 120- |
| | 130° C. |
| Crosslinker | Aliphatic polyisocyanate (HDI trimer), NCO content (DIN EN ISO |
| | 11909) 20-25% |
| Filler | CaCO3, mean particle size d₅₀ 5-10 μm |
| Wax | Fully saturated, long chain, linear primary alcohol |
| Resin | Liquid aromatic hydrocarbon resin |

### Non-Stripped Polyurethane Prepolymers PU1

The polyols (PO1X) and monomeric diisocyanate (P1) were reacted at a temperature of 120° C. using a typical preparation method to obtain a reaction product containing a polyurethane prepolymer and some unreacted monomeric diisocyanate. Composition of the non-stripped polyurethane prepolymers used for preparing the adhesive compositions Ex-1, Ex-2, and Ref-2 are shown in Table 3.

### Stripped Polyurethane Prepolymers PU2 and PUP

The polyols (PO2X, PO4) and the monomeric diisocyanates (P2X) were reacted at a temperature of 80° C. using a typical preparation method to obtain a reaction mixture containing a polyurethane prepolymer and unreacted monomeric diisocyanates. The reaction mixture was subjected to distillation with a short pass evaporator (jacket temperature 170 to 180° C., pressure 0.05 to 0.002 mbar, condensation temperature 47° C.) to reduce the content of volatile compounds, particularly the content of unreacted monomeric diisocyanates.
Distillation 1:170° C., p=0.03-0.05 mbar
Distillation 2:180° C., p=0.002-0.003 mbar
Rotation speed: 400 rpm
Flow rate: 8.05-8.62 kg/h

Composition and properties of the stripped polyurethane prepolymers are shown in Table 2.

### Acetylated Polyester Polyol APO

Amorphous polyester polyol (PO31) was first reacted with acetic acid anhydride at a molar ratio of 1:1 in a solution of acetic acid. The thus obtained reaction product was subjected to distillation to remove the solvent and residual (non-reacted) acetic acid anhydride.

TABLE 2
stripped polyurethane prepolymers

| | PU21 | PU22 | PU23 | PU24 | PU25 | PUP |
|---|---|---|---|---|---|---|
| Composition [wt.-%] | | | | | | |
| PO21 | 70.79 | | 70.79 | | | |
| PO22 | | 77.47 | | 77.47 | | |
| PO23 | | | | | 71.40 | |
| PO4 | | | | | | 29.93 |
| P21 | 29.21 | 22.53 | | | 28.60 | 70.07 |
| P22 | | | 29.21 | 22.53 | | |
| Molar NCO:OH ratio | 6:1 | 6:1 | 6:1 | 6:1 | 6:1 | 4:1 |
| Properties | | | | | | |
| Viscosity @25° C. [mPa s] | | | | | | 69000 |
| Viscosity @130° C. [mPa s] | 7000 | 6800 | 4600 | 4500 | — | — |
| Residual monomers [wt.-%] | 0.30 | 0.28 | 0.31 | 0.24 | — | 0.06 |

### Adhesive Compositions

Polyurethane prepolymers (PU1, PU2, or PU3) were mixed with other constituents of the adhesive composition and stirred (~80 rpm) at a temperature of 120° C. for 30 minutes. The thus obtained adhesive compositions were filled in tubes and stored at normal room temperature in the absence of moisture.

In case of adhesive compositions with polyurethane prepolymer PU3, the stripped polyurethane prepolymer (PUP) was first reacted with the polyol(s) (PO3X) at a temperature of 80° C. to obtain a reaction product containing the polyurethane prepolymer (PU3). The reaction product was mixed with the other constituents of the adhesive composition, if applicable, and stirred (~80 rpm) at a temperature of 120° C. for 30 minutes.

The adhesive composition of Ex-18 was prepared using a two-step process. In the first step, acetylated polyester polyol (APO) and thermoplastic polyurethanes (TPX) were mixed under continuous stirring at 160° C. until a homogenous mixture was obtained. In the second step, the temperature of the mixture was reduced to 120° C. and polyurethane prepolymers (PU2, PU3) were added into the mixture and stirred (~80 rpm) for 30 minutes.

The constituents of the adhesive compositions and their properties are presented in Tables 3-6.

### Open Time

The sample adhesive composition provided in a sealed tube was first preheated in an oven to at temperature of 110° C. for a time period of 30 minutes. After the heating, a sample of 20 g of the molten adhesive was applied with a doctor blade to surface of a silicone paper strip (B700 white, Laufenberg & Sohn KG) placed on a heating plate. The silicone paper strip had dimensions of 30 cm×10 cm and the adhesive was applied as a film having a thickness of 500 μm and dimensions of 30 cm×6 cm. Before applying the adhesive film, the silicone paper strip and the doctor blade were heated to a temperature of 110° C. with the heating plate.

Immediately after application of the adhesive, the silicone paper strip was removed from the heating plate and placed (with the adhesive film facing upwards) on a sheet of plywood at room temperature (23° C.) and the time was recorded as the starting point of the measurement. Every 10 seconds a short strip of silicone coated paper having dimensions of 10 cm×1 cm and formed in a roll (non-siliconized surface facing outwards) was placed on the adhesive film and then slowly removed to separate the strip from the adhesive film. The procedure was repeated until the paper strip could not be removed from the adhesive film without damaging the paper strip or the adhesive film. The time interval between the starting point of the measurement and the last sampling point was recorded as the open time (in seconds) of the adhesive composition

The values of open time presented in Tables 3-6 have been obtained as an average of three measurements conducted with the same adhesive composition.

### Green Strength (Tensile Lap-Shear Strength)

The adhesive was kept in an oven at 130° C. for more than 30 min to ensure the adhesive was provided in a molten state. After the heating, a sample of the molten adhesive was applied on the surface of a wood substrate having dimensions of 9 cm×2 cm×5 mm. The adhesive was applied as a coating film having dimensions of 2.5 cm×1 cm and a thickness of 1 mm.

Immediately after the application of the adhesive, a second wood substrate having same dimensions as the first wood substrate was positioned over the first wood substrate along the edge of the adhesive film to form a test composite element. The second wood substrate was pressed firmly against the first wood substrate to remove air from adhesive bond. A weigh of 150 g was placed on the top surface of the second wood substrate. Any adhesive squeezed out from the joint was trimmed off with a knife. Lap shear strength (LSS) of the test composite element was measured according to EN 1465 standard using a material testing apparatus (Zwick Z 020) and a test speed 10 mm/min. The lap shear strengths were measure with test composite elements, which had been stored for Jun. 10, 2020/30 minutes after the bonding of the first wood substrate with the second substrate to investigate the green (initial) adhesive bond strength obtained with the tested adhesive composition.

### Curing Time

A sample of the adhesive composition provided in a sealed tube was preheated in an oven to at temperature of 140° C. for 20 minutes. After the heating, a sample of 20 g of the molten adhesive was applied with a doctor blade to surface of a silicone paper (B700 white, Laufenberg & Sohn KG) strip placed on a heating plate. The silicone paper had dimensions of 30 cm×10 cm and the adhesive was applied as a film having a thickness of 500 μm and dimensions of 30 cm×6 cm. Before applying the adhesive film, the silicone paper strip and the doctor blade were heated to a temperature of 150° C. with the heating plate.

Immediately after application of the adhesive, the silicone paper strip was removed from the heating plate and stored at standard climatic conditions (23° C., 55% relative humidity). The point of time when the adhesive film was solidified was recorded as the starting point of the measurement. At defined sampling times, a test strip having dimensions of 10 cm×1 cm was cut from the silicone paper strip and placed on a heating plate having a temperature of 150° C. The procedure was continued until the adhesive film on the test strip no longer melted on the heating plate. The length of time interval between the starting point and the last sampling point was recorded as the curing time (in hours) of the adhesive composition.

The values of curing time presented in Tables 3-6 have been obtained as an average of three measurements conducted with the same adhesive composition.

### Tensile Strength and Elongation at Break

The adhesive composition provided in a sealed tube was preheated in an oven to at temperature of 110° C. for a time period of 30 minutes. After the heating, a sample of 40 g of the molten adhesive was applied with a doctor blade to surface of a silicone paper strip (B700 white, Laufenberg & Sohn KG) placed on a heating plate. The silicone paper had dimensions of 60 cm×10 cm and the adhesive was applied as a film having a thickness of 500 μm and dimensions of 60 cm×6 cm. Immediately after the application of the adhesive, the silicone paper strip was removed from the heating plate and stored at standard climatic conditions (23° C., 55% relative humidity) for a period of 7 days.

The measurements were conducted using a method based on DIN 53504 standard. Five rectangular test specimens having dimensions of 2.0 cm×8.0 cm were cut from a cured adhesive film having a thickness of 500 μm (cured for 14 days at 23° C./50% relative humidity). The test specimens were clamped into the tensile testing machine (Zwick Z 020) and pulled apart with a speed of 100 mm/min (test conditions 23° C., 50% relative humidity). The tensile strength and elongation at break were determined based on the measured maximum tensile stress.

The values of tensile strength and elongation at break presented in Tables 3-6 have been obtained as an average of five measurements conducted with the same adhesive composition.

### Viscosity

All viscosities were determined using a rotational viscometer Rheotec RC30 (cone diameter 25 mm, cone angle 1°, cone tip-plate distance 0.05 m, shear rate 50 s-1).

The values of viscosities in Tables 3-6 have been obtained as an average of three measurements conducted with the same adhesive composition.

### Heat Resistance (Heat Stability Under Static Load)

The adhesive composition provided in a sealed tube was preheated in an oven at a temperature of 130° C. for a time period of 20 minutes. After heating, a sample of molten adhesive was applied on the surface of a wood specimen (pine) having dimensions of 9 cm×2 cm×5 mm and having a 1 mm copper wire on its surface as a spacer. The adhesive was applied as a film having dimensions of 2 cm×2 cm and a thickness of 1 mm.

Immediately after the application of the adhesive a second wood specimen (pine) having same dimensions as the first wood specimen was positioned on the first wood specimen along the edge of the adhesive film to form a test composite element. The second wood specimen was pressed firmly against the first wood specimen to remove air from adhesive bond. A weigh of 150 g was placed on the top surface of the second wood specimen. Any adhesive squeezed out from the joint was trimmed off with a knife. The test composite elements consisting of bonded wood specimens were then stored for 14 days at standard climatic conditions (23° C., 40-60% relative humidity).

The test composite elements were then suspended vertically from one end of the first wood specimen on a metal hook and placed in an oven. A metal weight corresponding to a static load of 1 kg was attached to the lower end of the second wood specimen of each composite element. Three composite elements at a time were placed in the oven for the heat stability measurement.

In the heat stability measurement, the oven was first heated to a temperature, which is 40° C. below the anticipated adhesive bond failure temperature. The composite elements were kept at this starting temperature for 60 minutes. In case no bond failure occurred, the temperature of the oven was increased by 10° C. and the measurement was continued for another 60 minutes. The temperature of the oven was increased in steps of 10° C. following the procedure as described above until a bond failure occurred. The last measured temperature before the bond failure occurred was recorded as the representative heat stability temperature.

The heat resistance values for each adhesive composition presented in Tables 3-6 have been obtained as an average of three measurements conducted with identical test composite elements prepared by using the same adhesive composition.

### Content of Residual Monomeric Diisocyanates

The content of residual monomeric diisocyanate was determined using a high pressure liquid chromatography (HPLC) with photodiode array, 0.04 M sodium acetate/acetonitrile as mobile phase, and using N-Propyl-4-nitrobenzylamine as derivatization agent.

TABLE 3

| Composition [wt.-%] | Ref-1* | Ex-1 | Ex-2 | Ref-2 |
|---|---|---|---|---|
| PO11 | | 32.85 | 36.58 | 34.55 |
| PO12 | | 18.77 | 15.55 | 14.68 |
| PO13 | | | | 31.96 |
| P1 | | 6.16 | 6.71 | 11.9 |
| APO | | 34.72 | 33.84 | |
| TP1 | | 7.51 | 7.32 | 6.91 |
| Total | | 100.01 | 100.00 | 100.00 |
| Properties | | | | |
| Open time [min] | 30-35 | 60 | 30-40 | 20 |
| Green strength 6 min [MPa] | 0.1 | 0.07 | 0.07 | 0.45 |
| Green strength 10 min [MPa] | 0.2 | 0.12 | 0.11 | 0.93 |
| Green strength 20 min [MPa] | 0.45 | 0.17 | 0.23 | 2.06 |
| Green strength 30 min [MPa] | 0.50 | 0.21 | 0.30 | 2.75 |
| Curing time [h] | 24 | 24 | 24 | — |
| Tensile strength [MPa] | 20.0 | 8.2 | 8.9 | — |
| Elongation at break [%] | 650 | 590 | 620 | — |
| Viscosity @130° C. [mPa s] | 35000 | 48000 | 36000 | 85000 |
| Heat resistance [° C.] | 200 | 130 | 140 | — |
| Residual monomers [wt.-%] | 3.20 | 0.60 | 0.78 | 1.22 |

*SikaMelt-632

TABLE 4

| Composition [wt.-%] | Ex-3 | Ex-4 | Ex-5 | Ex-6 | Ex-7 | Ex-8 | Ex-9 | Ex-10 |
|---|---|---|---|---|---|---|---|---|
| PU21 | 42.86 | 42.45 | 42.25 | | | | | |
| PU22 | 9.52 | 9.43 | 9.39 | | | | | |
| PU23 | | | | 42.86 | 42.45 | 38.50 | 42.45 | 41.9 |
| PU24 | | | | 9.52 | 9.43 | 8.55 | | 9.30 |
| PU25 | | | | | | | 9.43 | |
| APO | 35.24 | 34.91 | 34.74 | 35.24 | 34.91 | 31.62 | 34.91 | 34.4 |
| TP1 | | | | | | | | |
| TP2 | 12.38 | 12.26 | 12.21 | 12.38 | 12.26 | 11.11 | 12.26 | 12.10 |
| Crosslinker | | 0.94 | 1.41 | | 0.94 | | 0.94 | 0.90 |
| Filler | | | | | | 10.22 | | 1.40 |
| Total | 100.00 | 99.99 | 100.00 | 100.00 | 99.99 | 100.00 | 99.99 | 100.00 |
| Open time [s] | 90 | 90 | 60 | 80 | 120 | 40 | 60 | 80 |
| Tensile strength [MPa] | 8.7 | 9.2 | 9.0 | 8.2 | 9.0 | 9.0 | — | 6.0 |
| Elongation at break [%] | 710 | 650 | 640 | 630 | 630 | 650 | — | 490 |
| Viscosity @130° C. [mPa s] | 18100 | 19800 | 30000 | 21300 | 15600 | 24500 | 20200 | 16300 |
| Green strength 30 min [MPa] | 2.68 | 2.74 | 2.45 | 2.39 | 2.47 | 2.47 | 3.6 | 2.22 |
| Heat resistance [° C.] | 150 | 160 | 160 | 130 | 140 | 140 | 150 | 140 |
| Curing time [h] | 21 | 24 | <17 | 25 | 26 | 27 | 21 | 24 |
| Residual monomers [wt.-%] | 0.14 | 0.17 | 0.07 | 0.12 | 0.09 | 0.1 | 0.16 | 0.16 |

TABLE 5

| Composition [wt.-%] | Ex-11 | Ex-12 | Ex-13 | Ex-14 |
|---|---|---|---|---|
| PU21 | | | | |
| PU22 | | | | |
| PU23 | | | | |
| PU24 | | | | |
| PUP | 52.50 | 53.00 | 47.12 | 50.41 |
| PO31 | 47.50 | | | |
| PO32 | | 47.00 | | |
| PO33 | | | 22.74 | 20.33 |
| PO34 | | | 15.86 | 13.88 |
| PO35 | | | 10.31 | 10.91 |
| PO36 | | | 3.97 | 4.46 |
| Total | 100.00 | 100.00 | 100.00 | 99.99 |
| Open time [s] | 10-15 | 10 | 20 | 30-40 |
| Tensile strength [MPa] | | | 15.8 | 17.9 |
| Elongation at break [%] | | | 310 | 290 |
| Viscosity @130° C. [mPa s] | | | 45000 | 38000 |
| Viscosity @140° C. [mPa s] | 15400 | 31000 | — | — |
| Green strength 30 min [MPa] | — | — | 0.76 | 0.66 |
| Heat resistance [° C.] | — | — | 160 | 160 |
| Curing time [h] | — | — | <24 | <23 |
| Residual monomers [wt.-%] | 0.06 | — | <0.1 | <0.1 |

TABLE 6

| Composition [wt.-%] | Ref-3 | Ex-15 | Ex-16 | Ex-17 | Ex-18 |
|---|---|---|---|---|---|
| PU21 | | 19.40 | 17.10 | 15.30 | 34.50 |
| PU22 | | 38.80 | 34.19 | 30.50 | |
| PU23 | 36.79 | | | | |
| PU24 | 46.80 | | | | |
| PUP | | | | | 23.00 |
| PO31 | | | | | 20.90 |
| APO | | 29.10 | 25.60 | 22.90 | 12.50 |
| TP1 | | | | | 6.30 |
| TP2 | 3.34 | 7.80 | 6.90 | 6.10 | 0.90 |
| TP3 | | 4.90 | 4.30 | 3.80 | |
| TP4 | 10.03 | | | | |
| Crosslinker | 1.00 | | | | |
| Filler | | | 11.91 | 21.40 | |
| Wax | 2.01 | | | | 1.90 |
| Total | 99.98 | 100.00 | 100.00 | 100.00 | 100.00 |
| Open time [s] | 60 | 120 | 60 | 90 | 50 |
| Tensile strength [MPa] | | 7.2 | 8.3 | 9.0 | 15.5 |
| Elongation at break [%] | | 660 | 640 | 620 | 420 |
| Viscosity @130° C. [mPa s] | 8200 | 37000 | 25000 | 32000 | 18800 |
| Green strength 30 min [MPa] | 1.5 | 0.66 | 0.67 | 0.72 | 1.87 |
| Heat resistance [° C.] | | 130 | 140 | 150 | 150 |
| Curing time [h] | | 23 | 24 | 24 | <24 |
| Residual monomers [wt.-%] | >0.20 | 0.01 | 0.08 | 0.08 | 0.11 |

1. An adhesive composition comprising at least one isocyanate-functional polyurethane polymer PU,
wherein the at least one isocyanate-functional polyurethane polymer PU comprises:
at least one isocyanate-functional polyurethane polymer PU1 obtained by reacting at least one polyester polyol PO1 and at least one diisocyanate P1 at a molar ratio of isocyanate groups to hydroxyl groups of 1.5-2.1, and/or
at least one isocyanate-functional polyurethane polymer PU2 obtained by reacting at least one polyester polyol PO2 and at least one diisocyanate P2 at a molar ratio of at least 3, and subjecting the thus obtained reaction mixture to a treatment to reduce the amount of residual monomeric diisocyanates, and
wherein the adhesive composition further comprises at least one acetylated amorphous polyester polyol APO
or wherein the at least one isocyanate-functional polyurethane polymer PU comprises:
at least one isocyanate-functional polyurethane polymer PU3 obtained by reacting at least one polyester polyol PO3 and at least one polyurethane prepolymer PUP at a molar ratio of isocyanate groups to hydroxyl groups of 1.9-3.5, and
wherein the at least one polyester polyol PO3 comprises at least one amorphous polyester polyol PO31 and wherein the adhesive composition optionally further comprises at least one acetylated amorphous polyester polyol APO.

2. The adhesive composition according to claim 1 having a content of monomeric diisocyanates of not more than 0.85 wt.-%, based on the total weight of the adhesive composition.

3. The adhesive composition according to claim 1, wherein the at least one acetylated polyester polyol APO is obtained by a method comprising reacting at least one amorphous polyester polyol with acetic acid anhydride at a molar ratio of from 1.3:1 to 1:1.3, followed by subjecting the reaction product to distillation to reduce the amount of residual acetic acid anhydride.

4. The adhesive composition according to claim 1, wherein the at least one acetylated polyester polyol APO is present in the adhesive composition in an amount of at least 5 wt.-%, based on the total weight of the adhesive composition.

5. The adhesive composition according to claim 1 comprising at least 15 wt.-%, based on the total weight of the adhesive composition, of the at least one isocyanate-functional polyurethane polymer PU.

6. The adhesive composition according to claim 1, wherein the at least one isocyanate-functional polyurethane polymer PU has an average isocyanate-functionality determined according to ISO 14896-2009 standard method A in the range of 1.2-2.7.

7. The adhesive composition according to claim 1, wherein the at least one diisocyanate P1 and P2 are monomeric diisocyanates.

8. The adhesive composition according to claim 1, wherein the at least one isocyanate-functional polyurethane polymer PU2 comprises:
at least one first isocyanate-functional polyurethane polymer PU21 obtained by reacting at least one polyester polyol PO21 and the at least one diisocyanate P2 and/or
at least one second isocyanate-functional polyurethane polymer PU22 obtained by reacting at least one polyester polyol PO22 and the at least one diisocyanate P2,
wherein the at least one polyester polyol PO21 is a at 23° C. solid polyester polyol and the at least one polyester polyol PO22 is a at 23° C. liquid polyester polyol.

9. The adhesive composition according to claim 1, wherein the at least one diisocyanate P2 comprises at least one diisocyanate P21 and/or at least one diisocyanate P22, wherein the at the at least one diisocyanate P21 is a monomeric diphenylmethane diisocyanate having a 2,4′-isomer content of at least 25 wt.-%, based on the total weight of the diisocyanate P21 and wherein the at least one diisocyanate P22 is a monomeric diphenylmethane diisocyanate having a 4,4′-isomer content of at least 75 wt.-%, based on the total weight of the diisocyanate P22.

10. The adhesive composition according to claim 1, wherein at least one polyurethane prepolymer PUP is obtained by reacting at least one polyester polyol PO4 and the at least one diisocyanate P2 at a molar ratio of at least 3, and subjecting the thus obtained reaction mixture to a treatment to reduce the amount of residual monomeric diisocyanates.

11. The adhesive composition according to claim 10, wherein the at least one polyester polyol PO4 comprises or consists of poly(tetramethylene ether)glycol.

12. The adhesive composition according to claim 1 further comprising at least one further thermoplastic polymer TP without isocyanate groups.

13. A method for producing an adhesive composition according to claim 1 comprising mixing of the at least one isocyanate-functional polymer PU and the other constituents of the adhesive composition with each other.

14. An assembly adhesive, laminating adhesive, or adhesive for the building of sandwich elements, comprising the adhesive composition according to claim 1.

15. A method for adhesively bonding a first substrate to a second substrate, the method comprising steps of:
I) heating an adhesive composition according to claim 1 to provide a melted adhesive composition,
II) applying the melted adhesive composition to a surface of the first substrate to form an adhesive film,
III) contacting the adhesive film with a surface of the second substrate, and
IV) chemically curing the adhesive film with water.
